(19) United States
(12) Patent Application Publication
(10) Pub. No.: US 2013/0253972 A1
(43) Pub. Date: Sep. 26, 2013

(54) SYSTEM AND METHOD FOR SCHEDULING AND ORDERING SERVICES

(71) Applicant: OPENDOCTORS 247, INC., New York, NY (US)

(72) Inventors: Josefina JERVIS, Manhasset, NY (US); Andrew S. HARRIS, Fairfield, NJ (US)

(73) Assignee: OPENDOCTORS 247, INC., New York, NY (US)

(21) Appl. No.: 13/842,418

(22) Filed: Mar. 15, 2013

Related U.S. Application Data
(60) Provisional application No. 61/613,798, filed on Mar. 21, 2012.

(51) Int. Cl. G06Q 10/10

(52) U.S. Cl. CPC G06Q 10/1095
USPC 705/7.19

(57) ABSTRACT

Computer-based system and computer-based method for providing a network-based scheduling service where clients or referring entities, after receiving and accepting an invitation from a service provider, are able to schedule appointments with the service provider.

### CROSS REFERENCE TO RELATED APPLICATIONS

The present application claims priority from U.S. application No. 61/613,798, entitled SYSTEM AND METHOD FOR ORDERING AND SCHEDULING THE DELIVERY OF SERVICES BY PROVIDERS, filed Mar. 21, 2012, the entire disclosure of which is incorporated by reference herein.

### BACKGROUND OF INVENTION

1. Field of Invention

The present invention relates generally to an integrated scheduling service and more particularly to a computer-based system and method for enabling a third party to schedule an appointment with a service provider, if the service provider has previously invited the third party to participate in the scheduling service. The appointment scheduled by a third party can be reflected on the electronic records management system of the service provider, regardless of the system used by the provider.

2. Description of Related Art

Service providers often maintain their schedules on a records management system that is part of a local computer network. A client wanting to book the services of a provider typically has to speak with a receptionist or clerk at the service provider's office in order to schedule an appointment. This process is completed either in person or over the phone. Other systems have been developed to allow clients to schedule appointments with a service provider through the use of a computer connected to a network, such as the internet, but such systems require the service provider to relinquish control of their schedule to a third party or to allow unsupervised access to their schedule. In these types of systems, the service provider's schedule is maintained on a remote database controlled by the third party. Alternatively, a service provider can maintain their own schedule while simultaneously maintaining a second schedule with a third party. This type of system often leads to conflicts between the two schedules that must be reconciled by the service provider, leading to decreased efficiency and wasted resources.

### BRIEF SUMMARY OF INVENTION

In one general aspect, the system and method of the present invention allow service providers to maintain control of their schedule while still enabling third parties, such as a client or a referring entity, to schedule appointments. Several features of the scheduling service are described in this application. For example, the application describes one feature where the client or referring entity uses a computer connected to a network, such as the internet, to schedule an appointment with the service provider. To enable the service provider to maintain control over his schedule, the system first requires the client or referring entity to be invited by the service provider before participating. If a referring entity is invited, the referring entity can schedule an appointment, prescribe services, and order procedures to be performed by the service provider. An additional feature reflects appointments scheduled by third parties on the service provider's records management system.

### BRIEF DESCRIPTION OF THE SEVERAL VIEWS OF DRAWINGS

By way of example, various embodiments of the present invention are described in the following figures:

FIG. 1 depicts a diagram of the process for a service provider to invite a patient and the patient, in turn, scheduling an appointment after accepting the invitation.

FIG. 2 depicts a diagram of the process for a service provider to invite a referring entity and the referring entity, in turn, scheduling an appointment after accepting the invitation.

FIG. 3 depicts a diagram of the process for a service provider to re-invite a referring entity.

FIG. 4 depicts a diagram of the process for a referring entity to schedule an appointment for the referring entity's clients.

FIGS. 5-12 are example screen shots of the web interfaces that may be provided to users of the scheduling service according to various embodiments of the present invention.

### DETAILED DESCRIPTION OF THE INVENTION

In one general aspect, the present invention is directed to a computer-based system and method for providing scheduling services, wherein clients and referring entities are invited by a service provider to schedule appointments with the service provider. The clients and referring entities utilize a network-connected computing device, such as a desktop computer, tablet, or phone, to order services or to view and select available appointments with the service provider. Only clients or referring entities that have received and accepted an invitation from the service provider are able to schedule an appointment with the service provider. In alternate embodiments, referring entities are able to transmit electronic prescriptions, patient history, and other relevant patient data to the service provider when ordering services or scheduling appointments.

The term service provider refers to any person, group, or entity that offers service in discrete time intervals or pursuant to a schedule. More generally, a service provider can be any person, business, or other entity that requires an appointment. For example, a service provider can include a doctor, a barber, a dentist, a nail salon, or a veterinarian. The term service provider can also include a person or entity whose services are providing access to a resource, like a tanning salon, for example. In the tanning salon example, an appointment is required to ensure the resource (i.e. a tanning bed) is available to use. The term client refers to any person or entity that utilizes the services of a service provider. A referring provider is any person or entity that requests services of a service provider on behalf of another person or entity.

The term requesting a service refers to scheduling an appointment, ordering a service, reserving a resource, or any other request made upon the service provider. For example, a doctor requesting a service from a radiologist could include scheduling an appointment for the doctor's patient or ordering an MRI examination on the patient's behalf.

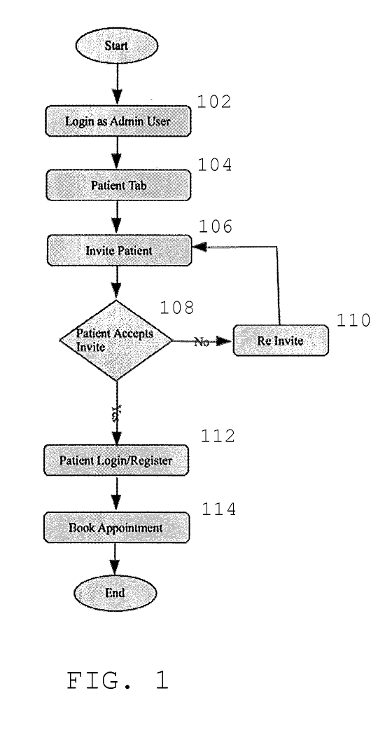

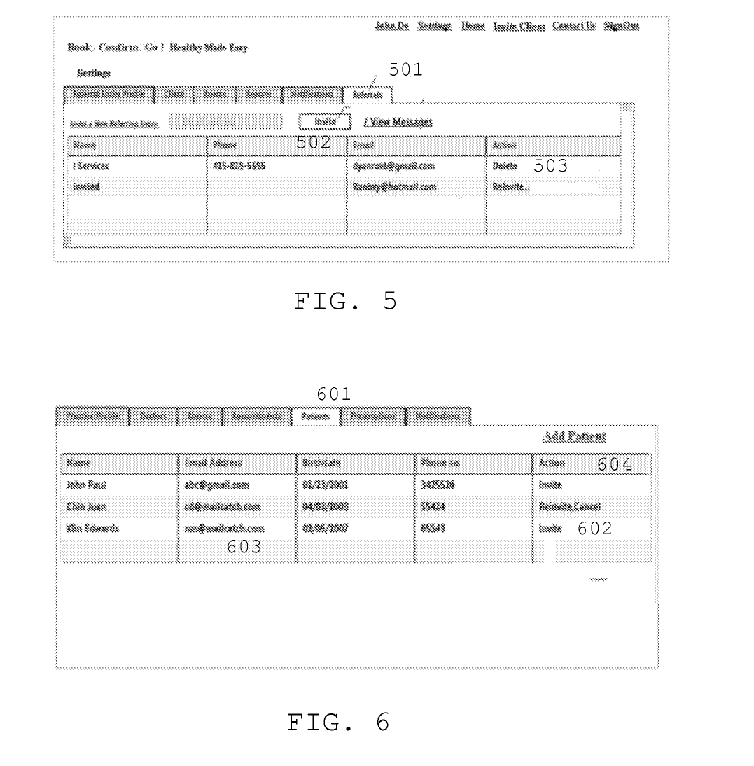

A service provider first registers with the invitation only scheduling program by creating a profile, which can be performed through a web interface or an application connected to a network, such as the internet. The service provider's profile is stored on a database connected to the network. After enrollment is completed, the service provider has the ability to invite referring entities or clients to participate in the scheduling service. The process of inviting a referring entity or client is described, by way of example, in FIG. 1. At step 102, a registered service provider or an employee of the service provider logs into the system as an administrator, thereby accessing the service provider's profile. Once logged into the system, the service provider is presented with an interface comprised of several tabs, as shown in FIG. 6. By logging in as an administrator, the service provider is able to access functions not available to other users, such as the invite button 602. At step 104, the service provider selects the patient tab 601 to access additional functions relevant to the service provider's patients. In other embodiments, such as with a service provider whose customers are not medical patients, the patient tab can be labeled as a client tab. At step 106, the service provider invites a patient. As shown in FIG. 6, the service provider can send an invitation to a client or patient from the interface, or web page, displayed under the patient tab 601. The invitation is as an electronic communication, such as an email, sent to the client. In this embodiment, the email address 603 of the client would be known since the invitation is being sent to an existing client of the service provider.

The client can choose to either accept or reject the invitation. A client must accept the invitation before being able to schedule an appointment. As such, in step 108, the system determines if the client has accepted the invitation. If the client has not accepted the invitation after a period of time, the service provider has the option of re-inviting the client by sending a new invitation at step 110. The service provider has the ability to determine the time period in which to re-invite the client, which can be a day, several days, several weeks, or any other period of time.

Upon accepting the invitation, the client is directed to register with the scheduling service at step 112. The client can perform the enrollment process by accessing a web-based interface through a network-connected computer, tablet, phone, or other electronic device having a web browser. After successfully registering, the client's status is updated in the Action column 604 on the patient tab 601 viewable by the service provider. After registering, the client has the ability to schedule an appointment with the service provider, as shown at step 114. The client's ability to schedule appointments can be revoked by the service provider. For example, if the client fails to show for a scheduled appointment, the service provider can select the delete action 503, removing the client's ability to access the scheduling service. However, unless the service provider revokes the client's permission to schedule appointments, the client can schedule appointments in the future without receiving an additional invitation.

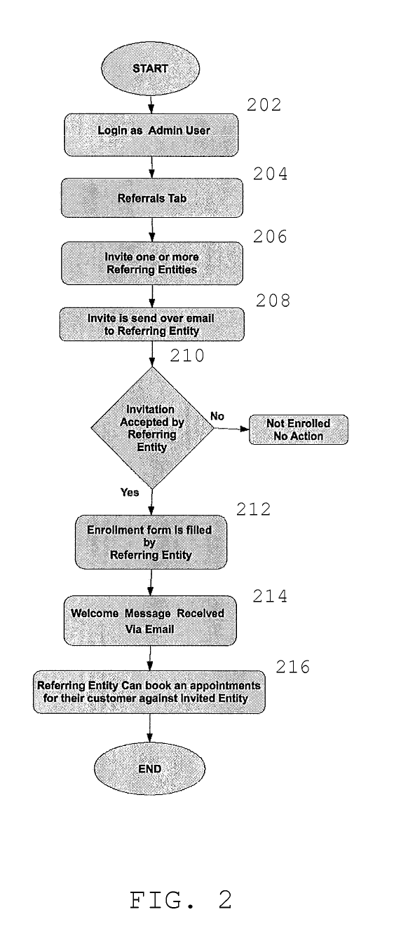

Referring now to FIG. 2, in another preferred embodiment, a process for a service provider inviting a referring entity to participate in the scheduling service is shown. For example, a doctor (the referring entity) that routinely sends patients to a radiologist (the service provider) can be invited by the radiologist to participate in the scheduling service. Inviting referring entities creates a business development opportunity for the service provider. In addition, the service provider increases efficiency by allowing the referring entity to directly schedule appointments and order services rather than having to place a call to the service provider's staff.

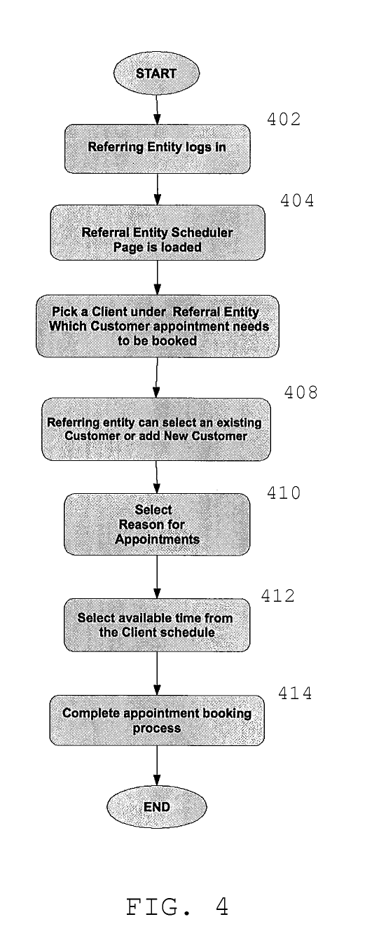

The process for inviting a referring provider is similar to the process for inviting a client. At step 202, the registered service provider first logs-in to the system as an administrator. At step 204, the service provider then selects the referrals tab 501 as shown in FIG. 5. When viewing the referrals tab 501, the service provider has the option to invite a referring entity by clicking on invite button 502 and shown at step 206. Multiple referring entities can be invited by repeating this step. At step 208, the invitation is sent via an electronic message, such as an email. Alternatively, if the referring entity is already enrolled in the scheduling service, a notification can be sent and displayed through the web interface. In this situation, the referring provider would be permitted to schedule appointments or order services with multiple service providers after accepting the most recent invitation. At step 210, it is determined if the referring entity accepted the invitation. At step 212, if the referring entity has accepted the invitation and is not already enrolled, the referring entity is directed to complete an enrollment form. On the enrollment form, the referring entity can supply information such as contact information, client data, and information related to the services offered by the referring provider. At step 214, if the referring entity was not previously enrolled, a welcome message is sent via email. After enrollment, the referring entity can book appointments for their customer with the service provider, as shown in step 216.

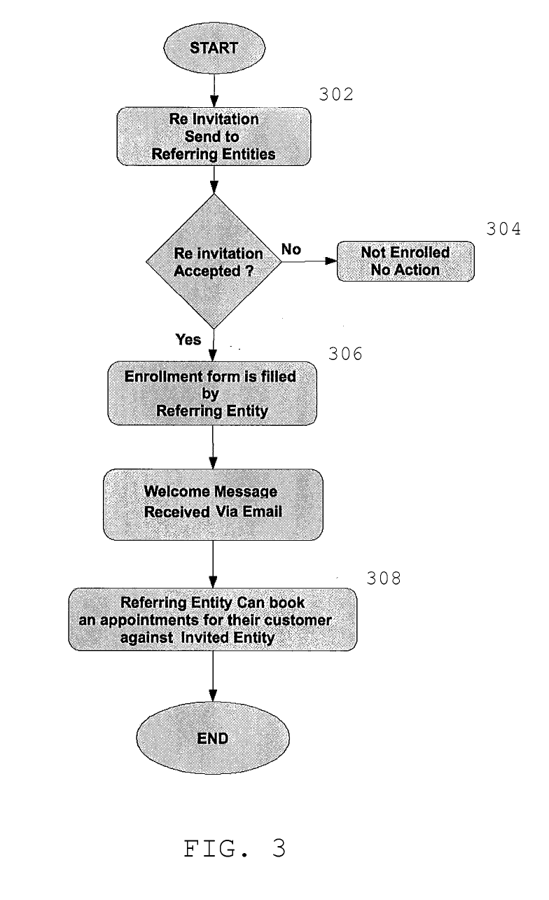

A service provider has the option to send a second invitation if the first invitation is not accepted. Referring now to FIG. 3, at step 302, a re-invitation is sent if the referring entity did not accept a previous invitation. The service provider is not limited in the number of re-invitations that can be sent. If the subsequent invitations are not accepted, then no further action is taken, as shown at 304. If the referring provider accepts the re-invitation, then the referring provider is prompted to complete enrollment (step 306) and begin scheduling appointments (step 308). The same process shown in FIG. 3 can be used to re-invite a client.

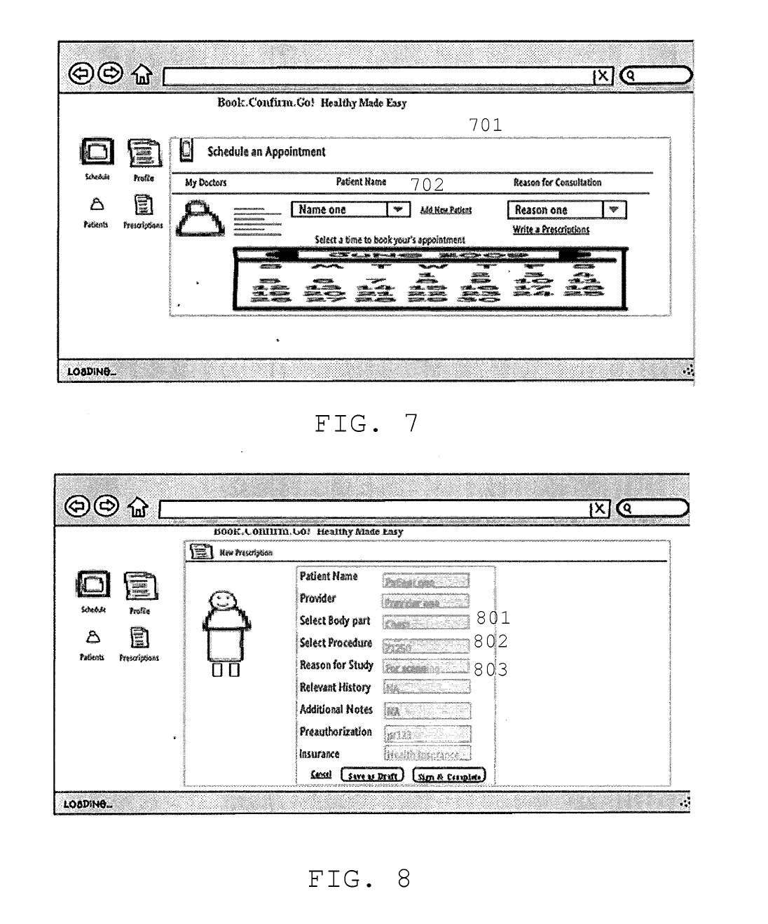

Once enrolled, the referring entity has the ability to schedule appointments for its clients with the service provider. As shown in FIG. 4, the referring entity first logs-in to the scheduling service at step 402. The referring entity can access the log-in screen through various methods, such as accessing the interface through a web browser or application running on a network-connected computing device. After log-in, at step 404, the referring entity is presented with the scheduler page 701, as depicted in FIG. 7. On the scheduler page 701, the referring provider can choose from a list of clients. In this embodiment, the referring entity choose a client from a drop down list 702. The list of clients can be populated from information provided by the referring entity during enrollment, clients for whom the referring entity previously scheduled appointments, or other sources. From the list of clients, the referring entity selects a client for which an appointment will be scheduled or selects the option to add a new client, as shown at step 408. If the referring entity chooses to add a new client, then the referring entity enters the client's information at this time.

After selecting a client, at step 410, the referring entity specifies the reasons for the appointment. For example, as shown in FIG. 8, the referring entity can select a body part 801 to be examined, the type of procedure 802, and the reason for the study 803, or examination. The options can differ from the ones displayed in FIG. 8 depending on the service ordered. In one particular embodiment, based on the reasons provided, a selection of available appointments is presented to the referring entity. For example, certain services might only be performed by one doctor in a practice group. If these services are specified in step 410, then only the available appointment times for that particular doctor who performs these services will be displayed. At step 412, the referring entity is given a choice of appointment times from the service provider's schedule. The scheduling process is complete at step 414 and the service provider is given notice of the appointment. Notice can be sent by email, text message, or any other electronic form of communication, such as a message displayed on the system when the service provider logs-in to the scheduling service interface.

If adding a new client at step 408, the referring entity will provide information regarding the client. As shown in FIG. 12, the information provided by the referring entity can include information such as date of birth 1201, address 1202, email address 1203, and insurance carrier 1204. It is contemplated that a service provider can specify what additional information is required about a client. Additional information can included items such as medical history, allergies, and other information typically requested from new patients. Providing this information at the time the appointment is scheduled rather than at the time of the appointment can shorten the time a client spends in the service provider's office on the day of the appointment.

In one embodiment of the present invention, the referring entity can accept invitations from multiple service providers. The referring entity enrolls after accepting an invitation from a first service provider. The referring entity can schedule appointments with respect to the service provider extending the initial invitation. Accepting an invitation from a second service provider will allow the referring entity to schedule appointments for the second service provider as well. The referring entity can schedule appointments with multiple service providers without creating multiple profiles or enrolling each time an invitation is accepted.

In yet another embodiment, the appointment scheduled by the referring entity is reflected on the service provider's local records management system. This feature is not exclusive to one particular type of records management system and works with all service providers and referring entities regardless of the records management system each use. For example, doctors often employ an electronic medical records (EMR) system, which includes scheduling functionality. Epic Systems Corporation is an example of one company offering EMR systems. In this embodiment, a primary care physician using a one EMR system can schedule an appointment for a patient with a radiologist who is using a different EMR system and the appointment will be recorded on the radiologist's EMR system.

In this embodiment of the present invention, the service provider's locally maintained schedule can be synchronized with a schedule maintained on a database accessible by clients or referring entities through the web interface. That is, appointments scheduled by a client or referring entity are displayed on the service provider's locally maintained schedule. Conversely, appointments scheduled on the service provider's locally maintained schedule are reflected on the schedule accessible by clients and referring entities, allowing real-time updates of the schedule.

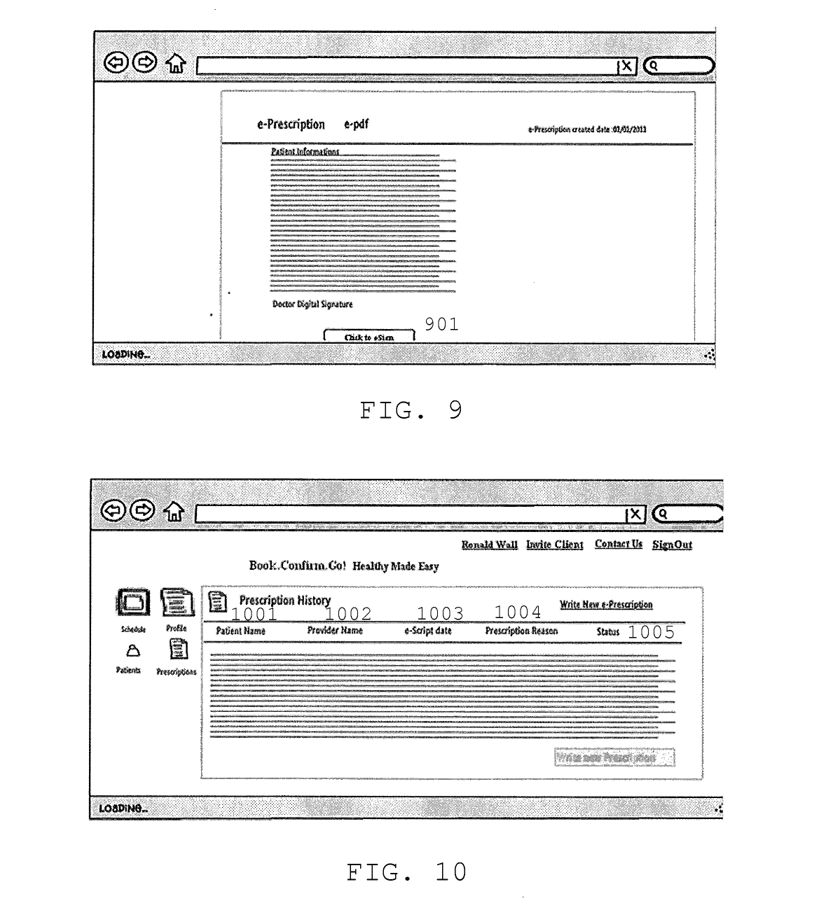

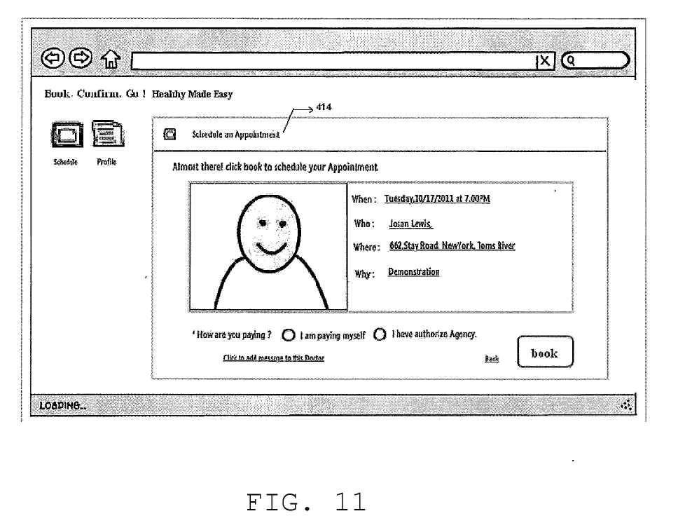

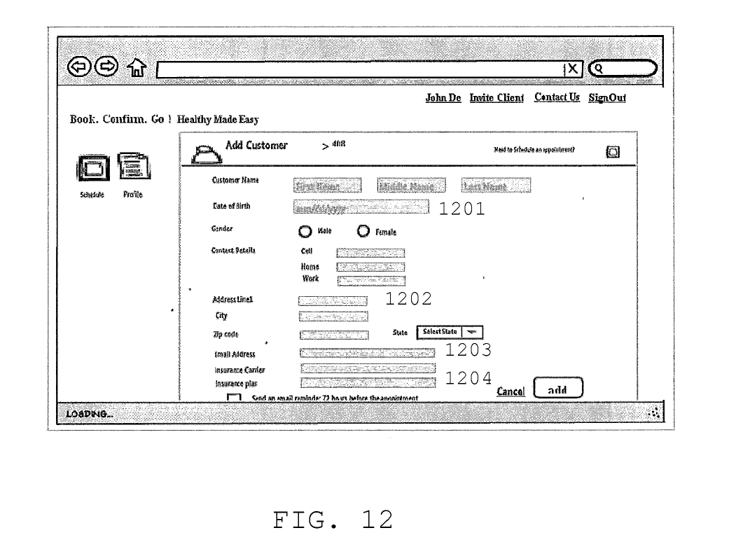

In another preferred embodiment, the referring entity can transmit a prescription or order for certain services on behalf of a client. This can be done whether or not an appointment is scheduled at the same time. For example, insurance companies routinely require a prescription from a patient's primary care physician before authorizing charges for a specialist visit. In this example, the primary care physician can transmit an electronic prescription, or e-prescription, to the specialist via a web interface. FIG. 9 depicts a web interface where a referring entity can create an order form for its client. In this example, the referring entity is a medical doctor. As shown in FIG. 9, the referring entity can sign the e-prescription by clicking on button 901. FIG. 10 is a screen of the web interface showing the history of e-prescriptions written by the referring entity. Information such as patient name 1001, provider name 1002, the prescription date 1003, the reason for the prescription 1004, and the status of the prescription 1005 can be displayed on this screen. A client, or patient, would not have access to these features.

The invention claimed is:

1. A computer-implemented method for providing a network-based service through which an invited external party is capable of requesting a service from a registered service provider, the method comprising:
transmitting from a computer-based electronic device via a network an invitation from at least one registered service provider inviting a party to request a service from the service provider, wherein the invitation is in the form of an electronic communication;
storing an attribute associated with the party on the electronic device;
receiving at the electronic device via the network a request from the party for the service, wherein the request is in the form of an electronic communication;
determining if the party is permitted to request the service based on the attribute;
if the party is permitted to request the service, storing the request for the service at the electronic device.

2. The method of claim 1 wherein the request for the service from the party is made on behalf of a second party.

3. The method of claim 1, further comprising:
transmitting from the computer-based electronic device via the network an invitation from a second registered service provider inviting the party to request a service from the second service provider, wherein the invitation is in the form of an electronic communication;
storing a second attribute associated with the party on the electronic device;
receiving at the electronic device via the network a request from the party for the service from the second service provider, wherein the request is in the form of an electronic communication;
determining if the party is permitted to request the service with the second service provider based on the second attribute;
if the party is permitted to request the service, storing the request for the service from the second service provider at the electronic device.

4. The method of claim 1 further comprising notifying the registered service provider of the request for the service.

5. The method of claim 1, further comprising synchronizing a request stored at the electronic device with at least one request stored on a computer-based electronic device of the service provider.

6. The method of claim 1, further comprising retransmitting the invitation if the party is not permitted to request the service.

7. The method of claim 1 wherein the attribute associated with the party comprises information indicating whether the party accepted the invitation.

8. The method of claim 1, further comprising:
receiving at the electronic device via the network a second request from the party for a second service, wherein the request is in the form of an electronic communication;
determining if the party is permitted to request the second service based on the attribute;
if the party is permitted to request the second service, storing the second request for the second service at the electronic device.

9. The method of claim 1 further comprising receiving at the electronic device via the network an instruction from the service provider modifying the attribute associated with the party, wherein the party is no longer permitted to request the service based on the modified attribute.

10. The method of claim 1 wherein the network is the internet.

11. A computer-based system for providing a network-based scheduling service, the system comprising:
at least one computer-based database for storing data;
at least one computer-based device in communication via a network with the at least one computer-based database, wherein the at least one computer-based device is programmed to:
transmit to the at least one computer-based database an invitation from at least one registered service provider inviting a party to request a service from the service provider;
receive a request from the party for the service;
determine if the party is permitted to request the service;
if the party is permitted to request the service, store the request from the party on the computer-based database.

12. The system of claim 11 wherein the request for the service from the party is made on behalf of a second party.

13. The system of claim 11 wherein the at least one computer-based device is further programmed to notify the registered service provider of the request for the service.

14. The system of claim 11 wherein the at least one computer-based device is further programmed to synchronize a request stored on the computer-based database with at least one request stored on a computer-based electronic device of the service provider.

15. The system of claim 11 wherein the at least one computer-based device is further programmed to retransmit the invitation if the party is not permitted to request the service.

16. The system of claim 11 wherein the network is the internet.
